(19) United States
(12) Patent Application Publication
(10) Pub. No.: US 2022/0406136 A1
(43) Pub. Date: Dec. 22, 2022

(54) SYSTEM AND METHOD FOR ISSUING RESTRICTED MONETARY VALUE TICKETS BASED UPON OUTSTANDING MARKER BALANCES

(71) Applicant: Everi Payments Inc., Austin, TX (US)

(72) Inventor: Timothy Brian Richards, Las Vegas, NV (US)

(21) Appl. No.: 17/831,684

(22) Filed: Jun. 3, 2022

Related U.S. Application Data
(60) Provisional application No. 63/213,480, filed on Jun. 22, 2021.

(51) Int. Cl. G07F 17/32

(52) U.S. Cl. CPC G07F 17/3244; G07F 17/3223

(57) ABSTRACT

A system is configured to issue restricted monetary value gaming vouchers or tickets which cannot be redeemed for cash when a player has an outstanding marker balance.

### RELATED APPLICATION DATA

The present invention claims priority to U.S. Provisional Application Ser. No. 63/213,480, filed Jun. 22, 2021.

### FIELD OF THE INVENTION

The present invention relates to casino gaming, including casino markers.

### BACKGROUND OF THE INVENTION

Casino game players need funds in order to participate in wagering activities. In some cases, such funds may not be readily available to a player, such as from traditional sources including an ATM, check cashing or the like. Frequently, casinos provide funds on credit to players, such as based upon a check of their credit-worthiness and/or based upon the player providing collateral. In particular, a player may seek a “marker”, which is generally a non-negotiable instrument that comprises a guarantee from the player to pay back funds provided by the casino. The marker generally has payment terms, such as a date by which the marker must be paid back before the casino seeks to collect on the marker (such as by executing on the player's collateral).

Generally, a casino that issues a marker to a player desires that the player use the marker funds at the casino, such as for wagering activities. If the casino issues chips to the player in the amount of the marker, the player may wager the chips, but may be prevented from redeeming the chips into cash and then leaving the casino. For example, if the player seeks to redeem the chips at a cashier station, the cashier may check and upon determining that the player has an outstanding marker balance, deny cash-out of the chips until or unless the player pays the outstanding balance of the marker.

When the casino provides marker funds in other manners, control over the user of the marker funds is more difficult. For example, a casino might associate funds with a player's wagering account and the player may then associate those funds with a gaming machine in the form of credits. The player might then seek to cash out their credit balance from the gaming machine. The player might then take those funds and leave the casino while a large unpaid marker balance remains.

Solutions to these and other problems are desired.

### SUMMARY OF THE INVENTION

Embodiments of the invention include, but are not limited to, methods and systems for tracking marker funds, including marker funds which are associated with a gaming device and then cashed-out into a monetary value ticket. Other aspects of the invention comprise methods and systems for issuing restricted monetary value tickets or vouchers, such as in response to a credit cash-out request from a player of a gaming device. Such restricted tickets or vouchers may permit a player to associate funds with another gaming device or otherwise present the ticket for use in other gaming activities, but may prevent the player from redeeming the ticket for money (e.g. currency/coins, deposit to bank account, etc.).

One embodiment of the invention comprises a gaming system comprising at least one gaming device at a casino, the at least one gaming device configured to present at least one wagering game in response to a wager by a player from a monetary value credit balance, the at least one account server in communication with the at least one gaming device, the at least one account server comprising a processor, at least one data storage element and machine-readable code stored by the at least one data storage element and executable by the processor, and at least one marker comprising data stored by the data storage element of the at least one account server, the data comprising information regarding an amount of outstanding credit to the player, the gaming device configured to receive a cash-out request from the player of the gaming device, and when the player has an amount of outstanding credit, the gaming device configured to issue at least one restricted monetary value ticket to the player, the ticket representing credits cashed-out of the gaming device and designated to not be redeemable for money.

Another embodiment of the invention comprises a method of providing casino credit to a player, relative to a gaming system, comprising the steps of: accepting an application for credit from a player, the application including information identifying the player; processing the application comprising determining if at least one qualifying criteria for issuance of a marker have been met; if so, issuing the marker, the marker defining available credit up to a maximum credit limit and permitting the player to access funds from the marker and create a marker balance; storing, in a memory associated with a financial server, information regarding the marker; determining, at the financial server in response to a cash-out request from the player at a gaming device, whether the player has an amount of credit outstanding relative to the marker balance; if not, causing the gaming device to issue a non-restricted monetary value ticket to the player, the ticket representing credits cashed-out of the gaming device and redeemable for money; and if so, causing the gaming device to issue at least one restricted monetary value ticket to the player, the ticket representing credits cashed-out of the gaming device and designated to not be redeemable for money.

In one embodiment of the system and method, when a restricted monetary value ticket is presented for redemption to credits, such as at another gaming machine, the ticket is redeemed. When the restricted monetary value ticket is presented for redemption into money/cash, such as at a redemption kiosk, the redemption is denied. In one embodiment, at the time of redemption, a restricted monetary value ticket may be automatically prevented from being redeemed into cash, or the system may be configured to recheck the player's marker balance, such as to determine if the balance has been paid, in which case the ticket may be redeemable for cash. In other embodiments, the status of a ticket may be updated after issuance, such as from a restricted status to an unrestricted status in the event the player pays off their credit balance. A player may also be permitted to use monetary value associated with a restricted monetary value ticket to pay off a credit balance, such as using a redemption kiosk.

Further objects, features, and advantages of the present invention over the prior art will become apparent from the detailed description of the drawings which follows, when considered with the attached figures.

### DESCRIPTION OF THE DRAWINGS

FIG. 1 is a diagram of a system in accordance with an embodiment of the invention; and

FIG. 2 illustrates a gaming machine in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention include, but are not limited to, methods and systems for tracking marker or “credit instrument” issued funds, including marker or credit instrument issued funds which are associated with monetary value tickets.

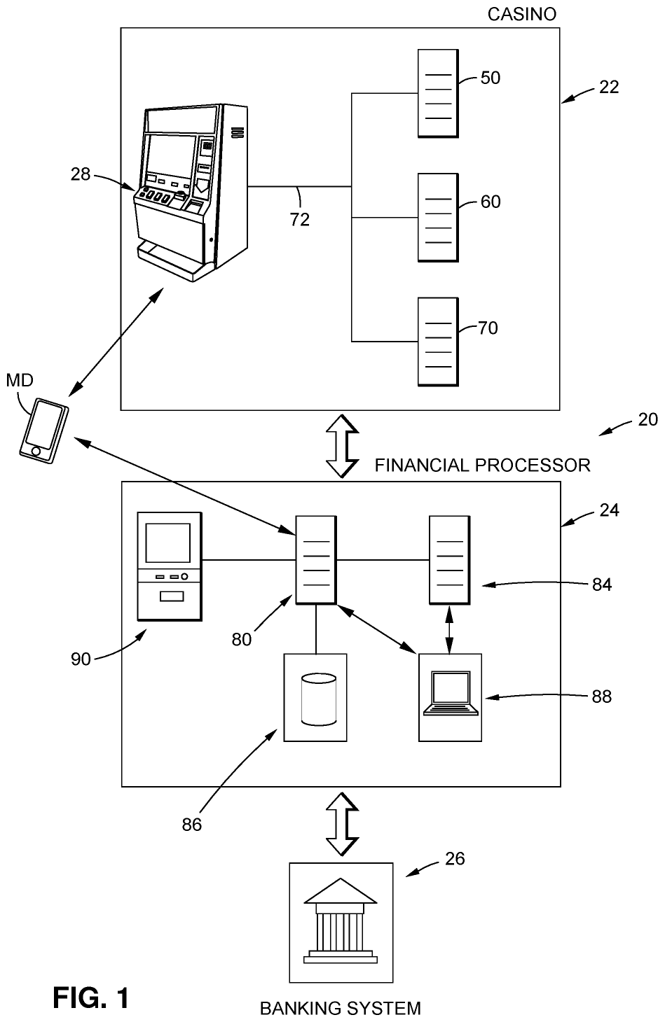

FIG. 1 illustrates one embodiment of the invention, which comprises a system 20. The system 20 may be referred to as a gaming system. As noted below, portions of the system might belong to or be operated by a casino (or the owner thereof) or entities other than a casino, and might be on-site or off-site as to the casino. In one embodiment, the system 20 may comprise elements associated with a casino system 22, a financial processor system 24, and an external financial network, such as a banking system 26.

The casino system 22 may comprise one or more devices and/or systems and may be associated with one or more physical locations. In one embodiment, the casino system 22 may include one or more gaming devices 28.

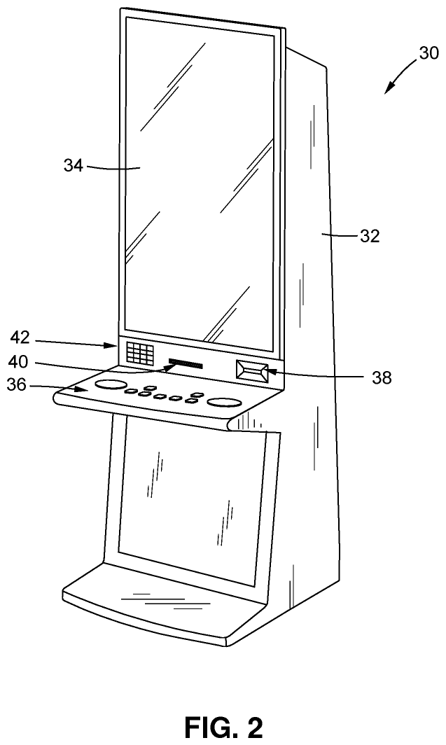

One embodiment of a gaming device is illustrated in more detail in FIG. 2, wherein the gaming device 28 comprises a gaming machine 30. As illustrated, the gaming machine 30 generally comprises a housing or cabinet 32 for supporting and/or enclosing various components required for operation of the gaming machine. The housing 32 may include one or more doors or access panels located at a front thereof, such as being configured to move between an open position which allows access to the interior, and a closed position in which access to the interior is generally prevented. The configuration of the gaming machine 30 may vary. In the embodiment illustrated, the gaming machine 30 has an “upright” configuration. However, the gaming machine 30 could have other configurations, shapes or dimensions (such as being of a “slant”-type, “bar-top” or other configuration as is well known to those of skill in the art).

The gaming machine 30 preferably includes at least one display device 34 configured to display game information. The display device 34 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 34 may be capable of projecting or displaying a wide variety of information, including images, symbols and other indicia or information associated with game play, game promotion or other events. The gaming machine 30 might include more than one display device 34, such as two or more displays which are associated with the housing 32. The gaming machine 30 might also include a top box or other portion. Such a top box might include one or more display devices, such as in addition to one or more main displays which are associated with the housing 32. Also, the gaming machine 30 might include side displays (such as mounted to the exterior of the housing 32) and might include multiple displays of differing sizes.

While the display devices may comprise one or more video displays, (such as for presenting video poker, video slots or other video-based games) in another embodiment, the gaming machine 30 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 30 is preferably configured to present one or more games upon a player making a monetary payment or wager. In this regard, as described in more detail below, the gaming machine 30 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 30 preferably includes a mechanism or means for returning unused monetary funds and/or dispensing winnings to a player.

The gaming machine 30 preferably includes one or more player input devices 36 (such as input buttons, plunger mechanisms, a touch-screen display, joystick, touch-pad or the like). These one or more devices 36 may be utilized by the player to facilitate game play, such as by providing input or instruction to the gaming machine 30. For example, such input devices 36 may be utilized by a player to place a wager, cause the gaming machine 30 to initiate a game, to indicate game inputs, to “cash out” of the gaming machine, or to provide various other inputs.

In one preferred embodiment, the gaming machine 30 includes at least one microprocessor or controller for controlling the gaming machine, including receiving player input and sending output signals for controlling the various components or peripheral devices of the machine 30 (such as generating game information for display by the display 34). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 34 (such as information comprising slot symbols, cards, etc.), and for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 30 may also include one or more random number generators for generating random numbers (such as implemented by a random number generator software module stored in the memory and executable by the processor or controller), such as for use in selecting slot symbols, cards or other game symbols and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine may be specially configured to present a game via specific software and/or hardware which causes the gaming machine to operate uniquely. For example, the controller of the gaming machine 30 may be configured to detect a wager, such as a signal from a player's depressing of the “bet one” button (such as one of the buttons 36). Upon such an event and/or the player otherwise signaling the gaming machine to present the game, the controller may be configured to cause the at least one display 34 to display unique information, such as a unique graphical interface or unique game display, including game symbols or other game information (such as graphically represented images of cards, slot symbols, dice, etc.). The controller may accept input from a player of game inputs, such as a request to spin reels or the like, via the one or more player input devices of the gaming machine 30. As indicated above, the machine readable code may be configured in various manners, such as by having various “modules” of software which are designed to implement specific features of the game play or game presentation.

The gaming machine 30 may be configured to generate and present games in a stand-alone manner or it may be in communication with one or more external devices at one or more times. For example, the gaming machine 30 may be configured as a server based device and obtain game code or game outcome information from a remote game server (in which event the gaming machine controller may receive game information from the server, such as game outcome information, and use that server-generated information to present the game at the gaming machine). For example, the gaming machine 30 might be configured as a stand-alone device or as a server-based device for presenting games as Class III games (as defined by the U.S. Indian Gaming Regulatory Act) or as a server-based device for presenting games as Class II games (as defined by the U.S. Indian Gaming Regulatory Act).

As indicated, the gaming machine 30 is configured to present one or more wagering games. The gaming machine 30 is preferably configured to accept value, such as in the form of coins, tokens, paper currency or other elements or devices representing value such as monetary funds. Thus, as indicated above, the gaming machine 30 preferably includes a mechanism or means for accepting monetary value. For example, as illustrated in FIG. 2, the gaming machine 30 might include a media reader 38. Such a reader may be configured to accept and read/verify paper currency and/or other media such as tickets or vouchers. Of course, in such event the gaming machine 30 may further be configured with one or more paper currency or ticket storage devices, such as cash boxes, and other paper currency or media handling devices (including transport devices).

The gaming machine 30 might also be configured to read FOB s, magnetic stripe cards or other media having data associated therewith and via which value or funds may be associated with the gaming machine 30. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 30 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 30 to indicate their desire to cash out, such as by selecting a “cash out” button (such as implemented via one of the buttons 36) or touch screen feature or providing other input. In response, a monetary value represented by the player's credit balance or the like is preferably paid, transferred or otherwise provided to the player. For example, upon an award or at cash-out, funds may be issued by dispensing paper currency or other media. In yet another embodiment, a player may be issued a media, such as a printed ticket, which ticket represents the value which was paid or cashed out of the machine. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet. As detailed below, in accordance with the invention, such tickets may comprise restricted tickets, such as which may limit their ability to be redeemed for money, or unrestricted tickets, such as which generally permit a player to redeem them for money.

The gaming machine 30 may also include a player tracking device, such as a card reader 40 and associated keypad 42. Such player tracking devices are well known and may permit the game operator to track play of players of the gaming machine. The tracked play may be utilized to offer player bonuses or awards. Of course, various means may be used for obtaining information which identifies a player (player tracking card, PIN number, ID number, bar code scan, biometric information, etc.), which information may be used to identify the player of the gaming machine, such as relative to data or other information which is associated with the player, such as at the casino system 22, financial processor system 24 or the like.

A casino may have numerous such gaming machines 30, such as located on a casino floor or in other locations. It will be appreciated that the gaming machine illustrated in FIG. 2 is only exemplary of one embodiment of a gaming machine. For example, it is possible to for the gaming machine to have various other configurations, including different shapes and styles and having different components than as just described.

Referring again to FIG. 1, the casino system 22 may include one or more system servers, such as one or more accounting or ticketing servers 50, a player account or casino management system server 60 and a game server 70. Such system servers preferably comprise computing devices which comprise at least one processor for receiving information, processing information or executing code or software, and generating an output, such as control instructions.

In one embodiment, each system server 50, 60, 70 includes means for storing information or instructions. Such means may comprise one or more memory devices. Such might comprise RAM, ROM (including EPROM, EEPROM, PROM) or other devices now known or later developed. In one embodiment, the servers may comprise or be in communication with one or more mass data storage devices, such as one or more hard drives or the like.

The system servers 50, 60, 70 preferably also include at least one communication interface, by which it may receive and transmit information. The communication interface(s) may permit communications in accordance with various protocols (TCP/IP, 802.11xx, etc.) and in various forms and over various types of links (wired and/or wireless).

Each system server 50, 60, 70 might actually comprise a system or network of a plurality of elements or devices. For example, each server might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the server, such as to change operator settings and the like. The system servers 50, 60, 70 might also comprise a router and one or more separate computing devices. The functions of the various computing devices might be segregated.

The one or more gaming device 28 are preferably in communication with the one or more system servers 50, 60, 70 at one or more times. For example, the gaming devices 28 and the one or more system servers 50, 60, 70 may be linked via one or more communication links 72. These communication links 72 may be wired and/or wireless and may be dedicated, shared, part of a LAN, WAN or other network, such as an internal casino network.

In one embodiment, the gaming devices 28 may communicate with the accounting/ticketing server 50, such as when seeking to print a monetary value ticket upon a cash-out request of a player (such as to create a ticket record and associated amount), or when a player seeks to redeem a monetary value ticket at the gaming machine (such as to validate the ticket and its amount). The accounting/ticketing server 50 may, for example, generate and maintain records of monetary value tickets, including their amounts, whether they have been cashed-out, etc., and/or may perform other functionality, such as accounting functionality (tracking and reconciling monetary value provided to the gaming devices 28, amounts wager, amounts won, amounts cash-out, etc.).

The gaming devices 28 may communicate with the player account server 60, such as to report player activity. The player account server 60 may maintain one or more player accounts, such as player loyalty accounts with game play information and loyalty awards, or monetary value accounts, such as accounts with associated monetary value that can be access by the player.

The gaming devices 28 may communicate with the game server 70, such as to obtain game information, including game outcome information, to facilitate progressive jackpots or other gaming functionality.

The gaming devices 28 may also comprise gaming tables at which one or more wagering games are presented. The casino system 22 may also include other elements, such as a sports book or system for accepting wagers on sporting events or the like.

As indicated, the system 20 preferably includes a financial processor system 24. Elements of this system may be operated by an entity which is separate from the casino and one or more of the element of the financial processor system 24 might be located at the casino or be remote therefrom. In other embodiments, financial processor system 24 might be part of the casino system 22, including being operated by the casino.

In one embodiment, the financial processor system 24 comprises one or more financial servers 80, an account server 82, a transaction and information database 84, and a processing system 88. In general, the financial server 80 may be configured to facilitate various requested financial transactions. The database 84 may be configured to store information, and particularly financial transaction and/or patron information. The account server 82 is preferably configured to implement account functionality, which may comprise marker account functionality, wallet account functionality, casino wagering account functionality and/or other account functionality. The processing system 88 may be used to generate settlement files, perform accounting/reconciliation, etc.

As illustrated, the financial processor system 24 or the casino system 22 may comprise one or more kiosks 90. The kiosk 90 may have various configurations. In one embodiment, the kiosk 90 comprises a housing, one or more devices for receiving player input and/or displaying or otherwise providing information to a player, and at least one credit dispensing mechanism. The information input/output devices may include, for example, an electronic touch-screen video display. Other input/output devices may include one or more push-buttons, keypads, keyboards and/or other elements. The credit dispensing mechanism may comprise, but it not limited to one or more of: a currency dispenser, a coin dispenser, a ticket or other media dispenser (such as a magnetic card dispenser), or a media writer (such an RFID encoder or the like).

In one embodiment, the kiosk 90 includes at least one processor for executing machine readable code or software, and at least one memory device for storing machine readable code or software for execution by the processor. In one embodiment, the kiosk 90 includes at least one communication interface, such as for establishing a communication link with one or more other devices, such as the financial server 80.

The casino system 22 and/or the financial processor system 24 may include other features, or elements. For example, they may include one or more cashier stations. Such stations may comprise, for example, a computing device which is configured to receive user input, and one or more displays, a processor, a memory, machine-readable code stored in the memory and executable by the processor, and at least one communication interface. Such a station may include a reader, such as for reading information associated with a ticket. The station may also include a cash dispenser or the like, such as for dispensing coins and/or currency.

In one embodiment, the financial processor system 24 is configured to communicate with an external financial network, such as the banking system 26.

Additional aspects of the system 20 (including the configuration of machine-readable code or “software” which is executable by the processors of the various devices of the system 20) will be appreciated from examples of use thereof as described below.

One example of the invention will now be described with reference to FIGS. 1 and 2. In one embodiment, a player may apply for a marker or credit instrument. This process might be implemented in various manners. For example, the player might seek a marker or credit instrument from the casino which then processes it via their own system, such as via their account server 60. The process might be implemented in paper, via a kiosk 90, or via a portable electronic device, such as a mobile device MD of the player. In other embodiments, the marker or credit instrument might be processed via the financial processor system 24, alone or in conjunction with the casino system 22. The process may comprise obtaining information from the player, such as identity information, and using that information to authentication the player, determine the creditworthiness of the player and/or verify and/or obtain collateral from the player (for example, the collateral may comprise funds in a player's checking or savings account, wherein the financial processor system 24 may communicate with the player's bank via the banking network 26 in order to verify the funds or to even obtain the funds to hold them in escrow). The process may comprise generating evidence of the marker or credit instrument, such as a paper or electronic record of the marker or credit instrument and its terms. The player may be required to sign the marker or credit instrument in order to accept it (electronically or physically). A record of the marker or credit instrument may be stored, such as in a memory or other data storage device which is associated with the account server 84 of the financial processor or the account server 60 of the casino.

Additional details regarding processing markers or credit instruments are provided in U.S. Pat. No. 9,293,002, which is co-owned by the Applicant of this application, which patent is incorporated in its entirety herein.

In general, once the marker instrument is issued, the player may access monetary value funds based upon the terms of the marker or credit instrument. For example, the marker may have a maximum credit amount and the player may obtain funds up to, in aggregate, the maximum credit amount. Funds which are provided to the player in accordance with the terms of the marker may be referred to as “marker funds” herein. Once a player has accessed funds associated with the marker or credit instrument, and until those funds are repaid, the player has an outstanding or unpaid marker or credit amount. An outstanding marker or credit amount may have repayment terms or deadlines.

In one embodiment, the marker or credit instrument funds may be associated with a player's account, such as an account associated with the account server 84 of the financial processor system 24 or the account server 60 of the casino system 22. In one embodiment, the player may access funds from their account for use at one of the gaming devices 28. For example, a player might transfer funds from their account to a gaming machine 30, thus establishing a balance of credits at the gaming machine 30 and/or increasing the credit balance.

As noted above, at one or more times, a player may wish to cash out their credit balance from a gaming machine 30. For example, upon selecting a cash-out option, the gaming machine 30 may be configured to print and dispense a printed ticket or voucher that represents the monetary value of the credits that are cashed-out of the gaming machine. The player might then take the ticket or voucher to another gaming device (another gaming machine, gaming table, etc.) in order to provide value for further wagering activities, or might seek to redeem the value of the ticket for money, such as at a redemption kiosk or cashier station (where the player is then given currency and/or coins in the amount of the ticket, the value of the ticket is transferred to a bank account, wallet, etc.).

In accordance with the present invention, if the player has an unpaid marker balance, then the player may be prevented from cashing out the credits associated with the gaming machine 30, including in a manner which permits the player to redeem the credits for cash. In one embodiment, if a player associates marker or credit instrument funds with a gaming machine 30 and has an unpaid balance thereof, then any credits cashed out of the gaming machine 30 may be restricted so that they cannot be redeemed for cash unless and until the player has paid off their outstanding marker or credit instrument balance. As detailed below, this might comprise, for example, flagging the cash-out ticket (such as by creating a restricted ticket which limits the redemption of the value of the ticket for money) to prevent the player from redeeming the ticket for cash/monetary funds.

Various embodiments of the invention are contemplated.

In one embodiment, features of the invention are integrated into the existing casino system 22, such as the ticketing server 50. For example, the software associated with the ticketing server 50 may be modified to cause the server to implement the functionality described herein. In one embodiment, when a player seeks to cash-out at the gaming machine 30, the gaming machine makes a call to the ticketing server 50 for a ticket in the amount of the credit balance at the gaming machine. The ticketing server 50 may then make a call to the casino account server 70 or the financial server 80 (whichever generated the marker/credit instrument and is tracking the balance thereof) to determine if the player has an outstanding marker balance. If the ticketing server 50 receive a response that the player does not have an unpaid marker balance, the ticketing server 50 may process the ticket request normally, creating and storing a record of an “unrestricted” ticket (one that can be redeemed at that gaming device or another gaming device for credits/chips, etc. or freely redeemed for money, such as currency or funds transfer to the player's bank account, etc.) and causing the gaming machine to issue such a ticket.

If the ticketing server 50 receives an affirmative response, the ticketing server 50 may generate a “marked” or restricted ticket and cause the gaming machine to issue the restricted ticket. Such a ticket may (when printed or issued by the gaming machine) bear information to the player that the ticket can't be redeemed for cash until or unless their outstanding marker balance is paid. Further, when the player presents the ticket, the ticket server 50 preferably again checks the ticket against the stored ticket records and: 1) may allow the ticket value to be credited if the ticket is being presented at another gaming device, or 2) may rejected the ticket if it is being presented for monetary redemption (such as by a cashier station or kiosk) or may only allow the ticket to be redeemed for money if, upon re-checking the player's marker balance (such as with the financial server 80), the player no longer has an unpaid marker balance.

This embodiment of the invention has the benefit that “flagged” or restricted tickets are generated by and tracked by the same ticket/accounting server 50 that is used to managed all monetary value tickets at the casino. A detriment to this embodiment is that the ticketing system/server 50 may be provided by an entirely different vendor than the vendor and system that the casino might use (e.g. such as the financial processor) to generate, issue and track markers, whereby effectuating such integration may be difficult.

It will be appreciated that while certain tickets are referred to herein as restricted, the tickets themselves may generally be the same as non-restricted/unrestricted tickets, except that the funds associated therewith are restricted in one or more regards, such as by limiting the redemption of those funds for money.

In another embodiment, the invention may be implemented by “intercepting” the cash-out and/or ticket presentment processes. This might be accomplished, for example, through the use of a secondary controller which is associated with the gaming machine 30 (such as which intercepts commands between the master gaming controller and the peripheral devices of the gaming machine, such as the ticket reader/printer thereof) or by a modified ticket printer/reader. In accordance with this embodiment, when a player seeks to cash-out, the cash-out request may be intercepted so that it is not routed to the ticketing/accounting server 50, but is instead routed, for example, to the financial server 80. The financial server 80 then determines whether the player has an outstanding marker balance. If not, the financial server 80 may route the ticket request to the ticketing/accounting server 50 to be fulfilled. If so, the financial server 80 may request the ticket from the ticketing/accounting server 50, and when received, flag that ticket and route it on to the gaming machine. Once again, the ticket may then be dispensed to the player and may include a notification that it cannot be redeemed for money until/unless any unpaid marker balance is paid.

In this embodiment, when the player presents the ticket at another gaming device (gaming machine, gaming table, sports book, etc. for wagering/use at the casino), the request may be routed to the ticketing/accounting server 50 and the credits may be provided to the gaming device. However, if the player presents the ticket for monetary redemption, such as at a kiosk 90 or a cashier station, the ticket redemption request may be routed to the financial server 80. The financial server 80 may then deny the redemption (such as based upon the flagged or restricted designation of the ticket) or may deny the redemption if there is still an outstanding marker balance or, if there is none, forward the request to the ticketing/accounting server 60 for approval and then forward the approval back to the kiosk 90 or cashier station.

In one embodiment of the invention, such as a variation of the embodiment above, two or more tickets or vouchers might be issued to a player at cash-out. As one example, the gaming machine may be configured to track marker funds, such as via a unique type of credit (e.g. differing from non-marker credits), such as by using one or more meters of the gaming machine. If there are marker credits on the gaming machine at cash-out, the cash-out might be intercepted and again routed to the financial server 80. The financial server 80 might issue a first ticket in the amount of the marker credits, while a second ticket might be generated by the ticketing/accounting server 60. The gaming machine 30 might then print and dispense two tickets, one that can be used at another gaming device 28 to establish wagering funds, but is otherwise flagged or restricted from being redeemed for money (unless the player has no unpaid marker balance), and another regular ticket that can be presented for credits a gaming device or be cashed out for money.

It will be appreciated that knowledge of whether a player that is cashing out has an unpaid marker or marker balance requires an identification of the player. This may be accomplished in various manners as is known in the art. For example, as noted above, when a player is issued a marker, the player's identity is confirmed. The marker may also be tied to a player tracking account of the player. When the player seeks marker funds at a gaming machine, they must provide information regarding their identity. This may comprise, for example, the player providing their player tracking account information (such as by using their player card, etc.). In other embodiments, the player might identify themselves in other manners, such as by using an electronic identifier. For example, the player might use their mobile device MD, such as by logging into and using a player tracking application or wallet application running on their device, to identify themselves. As illustrated in FIG. 1, the mobile device MD might communicate the identity information to a gaming device 28, or to a system, such as the financial server 80. In other embodiments, a player's identity might be determined or confirmed via use of one or more biometric identifiers (image, such as facial scan, fingerprint, etc.).

In one embodiment, further aspects of the invention may be implemented via player's mobile device MD. For example, a player may use a financial application (such as provided by the casino, the financial provider or the like) in order to apply for a marker/credit instrument or access funds from a marker/credit instrument, where in the mobile device MD serves as an interface to the process. In one embodiment, when a player requests marker funds, the funds might be routed from an account (such as associated with the financial processor system 24) through a casino management system (such as associated with or implemented by the account server 60) to the gaming machine 30. In another embodiment, however, the mobile device MD might link or sync directly to a gaming machine 30. For example, a ticket reader/printer might include a communication interface which permits communications with a player's device, such as via the application. When a player requests funds, the funds might be routed through their device to the ticket reader/printer, wherein the ticket reader/printer accepts the funds like a ticket redemption or currency input and signals credits to be added to the credit balance of the gaming machine 30.

In such a configuration, when the player elects to cash-out, a modified ticket reader/printer might communicate with the player's mobile device MD and the back end systems (such as the financial processor system 24), such as in the manner described above.

Additional aspects of the invention will now be described.

First, the principles of the invention may apply to both printed tickets or vouchers and virtual or electronic tickets or vouchers. Such virtual tickets might comprise, for example, an electronic image of a voucher, including a bar code, or might comprise other electronic information, such as a code. As one example, instead of printing a restricted ticket or voucher, an electronic image may be transmitted to the players mobile device MD. The player may presented the image in order to use the ticket, such as by causing the mobile device MD to display the image to a reader associated with a gaming device 28, such as one of the gaming machines 30, or a kiosk 90, etc. Again, the system of the invention may be configured to prevent the ticket from being redeemed for monetary funds if the ticket is restricted.

In one embodiment, the status of a ticket or voucher might be updated. For example, a ticket may be flagged or restricted when it is issued (either as designated by the ticketing server 50 or the financial server 80) due to the player having an outstanding marker balance. However, a player might thereafter pay off the marker. At such point, the status of the ticket as flagged might be updated, such as to remote the flag or other restriction on its redemption. This might comprise, for example, the financial server 80 or account server 70 sending information regarding the payment of the marker balance to the ticketing server 50 (or other instructions) which causes the ticketing server 50 to update the record for the ticket.

In one embodiment, if a player seeks to redeem a restricted voucher, the player might be given the opportunity to pay their outstanding marker balance, such as from the balance of funds associated with the ticket. Any remaining funds might then be dispensed to the player as currency/coins, etc. For example, a player might seek to redeem a restricted ticket at a kiosk 90. The kiosk 90 might communicate the ticket information to the financial server 80 which may confirm the restricted status of the ticket and a current outstanding marker balance. The financial server 80 might cause the kiosk 90 to display an option to the player that they may use the funds associated with the ticket to pay down or pay off the marker balance. If the marker balance is paid off, any other restricted tickets that the player possesses might be updated so that they can be redeemed for money, or such a status may be confirmed when the player presents those tickets. Further, any funds in excess of the amount paid to pay off the marker may be issued to the player (such as by currency/coin; credit to their bank account, etc.).

In one embodiment, a player might pay off their marker balance (or a portion thereof) by being permitted to redeem their player loyalty points.

As indicated herein, aspects of the invention may apply to gaming machines 30, but such may apply to other types of gaming devices 28, including gaming tables. For example, a gaming table may include a system for dispensing chips (such as based upon funds accessed from a marker), for redeeming chips, and for issuing one or more tickets representing the value of the chips. Such a system may communicate with the casino system 22 and/or financial processor system 24, such as for determining whether the player has an outstanding marker balance and, if so, causing one or more of the tickets that are provided to the player to be restricted/flagged in the manner described above. For example, a player might take out a marker at a gaming table (whether such marker is manually or electronically generated) and utilize funds from the marker to obtain chips for wagering at the gaming table. The player may wish to color up those chips (exchange them for funds/funds value) by turning them over to the dealer who may then input a value of the chips into an input interface of a ticketing system. In response, the system might cause a ticket printer at the gaming table (or adjacent thereto, such as in a gaming pit) to issue a restricted ticket to the player. Of course, the same principles might be applied even when a player does not utilize marker funds at a table. For example, a player might use cash funds to buy chips at a table and then later desire to color up those chips. The dealer might again interface with the ticketing system which may determine that the player has an outstanding marker, which if unpaid, may cause the system to issue a restricted ticket to the player for the value of those chips. The same process may apply if a player takes their chips from the gaming table and attempts to cash them in at a cashier station or the like.

The same principles of the invention may apply to a kiosk or other devices (sports books and other gaming locations). For example, a kiosk or similar station may allow a player to either apply for and obtain a marker, or obtain funds from a marker or other credit line. Those accessed funds may be provided to the player in the form of a ticket having the associated value. In such an instance, the ticket may be issued as a restricted ticket. For example, a player might apply for a $5,000 marker via an automated kiosk and see $1,000 in funds from that marker credit line, or might seek $1,000 from an existing marker. In either case, the funds may be issued to the player in the form of a ticket having associated value of $1,000. However, that ticket may be restricted, thus permitting the player to utilize the ticket to fund gaming (such as by presentation to a gaming device), but not permitting the player to redeem the ticket for money (e.g. cash, to monetary funds associated with a bank account, etc.).

The features of the invention may be applied or implemented based upon various criteria. For example, anytime a player seeks to cash-out of a gaming device 28, such as a gaming machine 30, it may be determined whether the player has a marker balance. If so, the one or more issued tickets may be flagged or restricted in the manner described above, even though the funds that are associated with the gaming device might have been provided by the player rather than being provided from a marker.

In another embodiment, the one or more tickets may be flagged or restricted in the manner described above if the player obtained funds from their marker as part of establishing credits for game play at the gaming device 28 that they are now cashing out of. This might be determined, for example, by determining “gaming sessions.” For example, a gaming session at a gaming device 28 might start when the player “cards-in” (e.g. identifies themselves, such as by inserting their player tracking card). In such a configuration, if a player accesses marker funds between when they card-in or otherwise are determined to have started a gaming session and when they cash-out, then one or more of the tickets which are issued to the player might be restricted.

In another embodiment, one or more restricted tickets may be issued to a player based upon other criteria. In one embodiment, as noted above, multiple tickets might be issued to a player, including one or more unrestricted tickets and or more restricted tickets. In one embodiment, a player might be permitted to transfer a portion of their credit balance to an unpaid marker in order to pay it. For example, at cash-out and upon a determination that the player has an unpaid marker balance, the player may be given (such as from the gaming machine 30) the opportunity to pay their marker balance down or paid it off entirely, in which case the player may cash out any remaining funds to an unrestricted ticket.

Markers often have redemption terms, including a time period by which the marker must be redeemed or paid. In one embodiment of the invention, if the player has a marker with an open or unpaid balance and the marker has not entered a redemption period, then even if the player has an unpaid balance, the player may not be issued one or more restricted tickets. However, if the player's marker is in its redemption period and has an unpaid marker balance, then the player would be issued one or more restricted tickets.

In some embodiments, the gaming device might issue two ticket. One ticket may be restricted and have an amount of funds (from cashed-out credits) associated therewith that is equal to the unpaid marker balance of the player. Another ticket may be unrestricted and have an amount of funds associated therewith that is equal to the cashed-out credits less the unpaid marker balance of the player (e.g. cash-out credits which exceed a player's marker balance might be cash-out in an unrestricted manner).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming system comprising:
at least one gaming device at a casino, said at least one gaming device configured to present at least one wagering game in response to a wager by a player from a monetary value credit balance;
at least one account server in communication with said at least one gaming device, the at least one account server comprising a processor, at least one data storage element and machine-readable code stored by said at least one data storage element and executable by said processor; and
at least one marker comprising data stored by the data storage element of said at least one account server, said data comprising information regarding an amount of outstanding credit to said player;
said gaming device configured to receive a cash-out request from said player of said gaming device; and
when said player has an amount of outstanding credit, said gaming device configured to issue at least one restricted monetary value ticket to said player, said ticket representing credits cashed-out of said gaming device and designated to not be redeemable for money.

2. The gaming system in accordance with claim 1, wherein said information regarding an amount of outstanding credit comprises information regarding whether an amount of credit is unpaid.

3. The gaming system in accordance with claim 1, wherein said gaming device is configured to transmit a request for a ticket to said at least one account server and said at least one account server is configured to check said data storage element for information regarding an amount of outstanding credit to said player.

4. The gaming system in accordance with claim 1, wherein said gaming device is configured to receive information which identifies said player and transmit said information to said at least one account server for use in determining whether said player has an amount of outstanding credit.

5. The gaming system in accordance with claim 1, further comprising at least one kiosk, said kiosk configured to read information which identifies said ticket when said ticket is presented at said kiosk and to transmit a request to validate said ticket for redemption to said at least one account server.

6. The gaming system in accordance with claim 5, wherein said at least one account server is configured to deny said request for validation.

7. The gaming system in accordance with claim 6, wherein said request for validating is denied when said player has an amount of outstanding credit at the time said ticket is presented to said kiosk.

8. The gaming system in accordance with claim 5, wherein said at least one account server is configured to credit said amount of outstanding credit with a said amount of credit associated with said ticket.

9. The gaming system in accordance with claim 1, further comprising at least one second gaming device, said second gaming device configured to read information which identifies said player and transmit said information to said at least one account server and, when validated, cause said second gaming device to credit said amount of credit associated with said ticket.

10. The gaming system in accordance with claim 1, wherein said at least one account server comprises a server of a financial vendor.

11. The gaming system in accordance with claim 10, further comprising a ticketing server, wherein said gaming device is configured to transmit a request for a ticket to said ticketing server

12. The gaming system in accordance with claim 11, wherein said ticketing server is configured to, in response to receiving said request for said ticket, to transmit a request to said at least one account server to check said data storage element for information regarding an amount of outstanding credit to said player.

13. The gaming system in accordance with claim 1, further comprising at least one secondary controller communicatively coupled to said gaming device and configured to receive said cash-out request, and in response thereto, transmit a signal to said at least one account server, said at least one account server configured to transmit a signal back to said gaming device which causes said gaming device to, when said player does not have an amount of outstanding credit, issue a non-restricted monetary value ticket to said player, said non-restricted monetary value ticket representing credits cashed-out of said gaming device and redeemable for money, and when said player does have an amount of outstanding credit, issue at least one restricted monetary value ticket to said player, said restricted ticket representing credits cashed-out of said gaming device and designated to not be redeemable for money.

14. The gaming system in accordance with claim 1, wherein said when said player does not have an amount of outstanding credit, said gaming device is configured to issue a non-restricted monetary value ticket to said player, said non-restricted monetary value ticket representing credits cashed-out of said gaming device and redeemable for money.

15. A method of providing casino credit to a player, relative to a gaming system, comprising the steps of:
accepting an application for credit from a player, said application including information identifying said player;
processing said application comprising determining if at least one qualifying criteria for issuance of a marker have been met;
if so, issuing said marker, said marker defining available credit up to a maximum credit limit and permitting said player to access funds from said marker and create a marker balance;
storing, in a memory associated with a financial server, information regarding said marker;
determining, at said financial server in response to a cash-out request from said player at a gaming device, whether said player has an amount of credit outstanding relative to said marker balance;
if not, causing said gaming device to issue a non-restricted monetary value ticket to said player, said ticket representing credits cashed-out of said gaming device and redeemable for money; and
if so, causing said gaming device to issue at least one restricted monetary value ticket to said player, said ticket representing credits cashed-out of said gaming device and designated to not be redeemable for money.

16. The method in accordance with claim 15, further comprising the step of determining, at said financial server in response to presentation of said restricted monetary value ticket by said player for redemption, whether said player has an amount of credit outstanding relative to said marker balance.

17. The method in accordance with claim 16, wherein said restricted monetary value ticket is presented to at least one of a redemption kiosk, a cashier, and a second gaming device.

18. The method in accordance with claim 15, wherein said step of issuing comprises printing said ticket.

19. The method in accordance with claim 15, further comprising the step of receiving said at least one restricted monetary value ticket at a redemption kiosk and preventing the dispensing of money from said kiosk in response to a requested redemption of said at least one monetary value ticket.

20. The method in accordance with claim 15, further comprising the step of receiving payment of said amount of credit outstanding relative to said marker balance and changing a designation of said at least one restricted monetary value ticket to a non-restricted monetary value ticket.
